(19) United States
(12) Patent Application Publication
(10) Pub. No.: US 2021/0197128 A1
(43) Pub. Date: Jul. 1, 2021

(54) METHOD FOR HEALING DAMAGED SEPARATION MEMBRANE FOR WATER TREATMENT USING SURFACE-FUNCTIONALIZED SILICA MICROPARTICLES

(71) Applicants: YALE UNIVERSITY, New Haven, CT (US); KOLON GLOBAL CORPORATION, Gyeonggi-do (KR)

(72) Inventors: Bezawit GETACHEW, New Haven, CT (US); Sang-ryoung KIM, Gyeonggi-do (KR); Jae-hong KIM, Madison, CT (US); Seung-joon KIM, Seoul (KR); Seong-kyun YIM, Seoul (KR); Moon-sun KANG, Gyeonggi-do (KR)

(73) Assignees: YALE UNIVERSITY, New Haven, CT (US); KOLON GLOBAL CORPORATION, Gyeonggi-do (KR)

(21) Appl. No.: 16/077,950

(22) PCT Filed: Dec. 26, 2017
(86) PCT No.: PCT/KR2017/015504

§ 371 Date: Aug. 14, 2018

(30) Foreign Application Priority Data
Dec. 26, 2017 (KR) 10-2017-0179580

(51) Int. Cl. B01D 65/10; C02F 1/44

(52) U.S. Cl. CPC B01D 65/108; C02F 2303/14; C02F 1/44

(57) ABSTRACT

A method for healing a damaged separation membrane for water treatment uses silica microparticles surface-functionalized with polyethyleneimine. The method can be applied to actual water treatment processes because the particle size and chemical stability of the silica microparticles surface-functionalized with polyethyleneimine are maintained under various operation conditions are used. A separation membrane for water treatment healed exhibits superior healing performance, with water permeability and rejection rate being healed to 90% or higher as compared to the pristine separation membrane, and maintains physical and chemical stability for a long time. Moreover, the method is advantageous in that flux does not declines after the healing because the silica microparticles surface-functionalized with polyethyleneimine are selectively deposited on the damaged part. In addition, it is advantageous in terms of economy in that silica microparticles commercially available at low cost are used.

### CROSS REFERENCE TO RELATED APPLICATIONS AND CLAIM OF PRIORITY

This application claims benefit under 35 U.S.C. 119(e), 120, 121, or 365(c), and is a National Stage entry from International Application No. PCT/KR2017/015504, filed Dec. 26, 2017, which claims priority to the benefit of Korean Patent Application No. 10-2017-0179580 filed in the Korean Intellectual Property Office on Dec. 26, 2017, the entire contents of which are incorporated herein by reference.

### TECHNICAL FIELD

The present disclosure relates to a method for healing a damaged separation membrane for water treatment using surface-functionalized silica microparticles, more particularly to a method for healing a damaged separation membrane for water treatment using silica microparticles surface-functionalized with polyethyleneimine.

### BACKGROUND ART

Low-pressure separation membranes including microfiltration (MF) separation membranes and ultrafiltration (UF) separation membranes have gradually become the standard of water treatment processes in the last decade. The low-pressure separation membranes are mainly used independently for removal of micrometer-sized pathogens or particles or for pretreatment for nanofiltration or reverse osmosis. When these separation membranes are damaged, water quality may worsen as the micrometer-sized pathogens or particles pass through the separation membranes.

Accordingly, the separation membrane industry has developed direct/indirect tests for monitoring the integrity of the low-pressure separation membranes and regulatory agencies are calling for periodic monitoring of the integrity of the separation membranes.

Although there have been sufficient researches on the test of integrity of the separation membranes, the technology of healing damaged separation membranes has not been researched enough.

In this regard, a technology of healing a damaged separation membrane by filtering a suspension of chitosan aggregates through the separation membrane has been developed (non-patent document 1 and non-patent document 2). The chitosan aggregates block the damaged part of the separation membrane through increased hydraulic drag force and, subsequently, a sealing matrix is formed via crosslinking with glutaraldehyde without module disassembly. Although this healing technology shows satisfactory results for flat sheets and hollow fiber separation membranes, there are some limitations in application to actual water treatment processes.

Firstly, this healing technology is applicable only to separation membranes having pores smaller than the chitosan aggregates. Chitosan aggregates smaller than the pores of the separation membrane may block the pores on the intact part of the separation membrane, thereby lowering the permeability of the separation membrane. Although the size of the aggregates can be controlled to 0.5-2.2 μm by adjusting pH, it is difficult to precisely control the pH of the injected aggregates through the process.

In addition, the size of the chitosan aggregates may be changed due to various causes such as the chemicals remaining in the separation membrane system, powerful air flushing or coagulation between chitosan and anionic materials.

Secondly, in the water treatment system, the crosslinked chitosan is sensitive to pH and may exhibit decreased chemical stability due to the biodegradable β-(1,4)-glycosidic bonds between D-glucosamine and N-acetyl-D-glucosamine.

Under acidic conditions, the crosslinked chitosan is expanded due to the protonation of the amino group. But, it shrinks to its original size under neutral conditions. This reversible expansion and shrinkage lead to decreased performance of the chitosan with time. In addition, the β-(1,4)-glycosidic bonds may be hydrolyzed by lysozymes, chitinases, chitosanases, etc., which may detected in the water treatment system due to the presence of bacteria and molds.

Accordingly, there remains the problem that the chemical stability of chitosan exposed to wastewater for a long time in actual applications is not sufficiently reliable.

### SUMMARY

The present disclosure is directed to providing a method for healing a damaged separation membrane for water treatment that can be employed under various operation conditions.

The present disclosure is also directed to providing a method for healing a damaged separation membrane for water treatment that can ensure the healing performance and chemical stability of the healed separation membrane.

The present disclosure provides a method for healing a damaged separation membrane for water treatment, which includes:

a step of filtering a solution containing polyethyleneimine-functionalized silica microparticles through a damaged separation membrane for water treatment;

a step of filtering a solution containing a dialdehyde compound through the damaged separation membrane for water treatment; and

a step of crosslinking the polyethyleneimine-functionalized silica microparticles with the dialdehyde compound.

The polyethyleneimine may be a branched polyethyleneimine.

The polyethyleneimine may have a weight-average molecular weight of 1,000-100,000 Da.

The polyethyleneimine-functionalized silica microparticles may be particles modified as —(CH₂)ₙNH(CH₂)ₙSO₂(CH₂)ₙ— (n is an integer from 1 to 5) groups formed on the surface of silica beads are bound to a polyethyleneimine.

The polyethyleneimine-functionalized silica microparticles may be microparticles prepared by a method including:

a step of preparing aminopropyl-functionalized silica microparticles by reacting silica microparticles with (3-aminopropyl)-triethoxysilane;

a step of preparing vinylsulfone-functionalized silica microparticles by reacting the aminopropyl-functionalized silica microparticle with divinylsulfone; and

a step of reacting the vinylsulfone-functionalized silica microparticles with a polyethyleneimine.

The dialdehyde compound may be one or more selected from glutaraldehyde, glyoxal, malondialdehyde, succindialdehyde, maleindialdehyde and phthaldialdehyde.

The crosslinking may be achieved by forming an imine bond between the amine group of the polyethyleneimine and the aldehyde group of the dialdehyde compound.

A method for healing a damaged separation membrane for water treatment according to the present disclosure can be applied to actual water treatment processes because “silica microparticles surface-functionalized with polyethyleneimine” whose particle size and chemical stability are maintained under various operation conditions are used.

A separation membrane for water treatment healed according to the present disclosure exhibits superior healing performance, with water permeability and rejection rate being healed to 90% or higher as compared to the pristine separation membrane, and maintains physical and chemical stability for a long time.

Moreover, the method for healing a damaged separation membrane for water treatment according to the present disclosure is advantageous in that flux does not declines after the healing because the silica microparticles surface-functionalized with polyethyleneimine are selectively deposited on the damaged part.

In addition, it is advantageous in terms of economy in that silica microparticles commercially available at low cost are used.

### BRIEF DESCRIPTION OF THE DRAWINGS

FIG. 1 describes a method for synthesizing and polyethyleneimine-functionalized silica microparticles and fluorescence-labeled polyethyleneimine-functionalized silica microparticles.

Abbreviations mean the followings.

SiO₂ MPs: bare silica microparticles;

SiO₂-APTES MPs: SiO₂ MPs amine-functionalized using APTES ((3-aminopropyl)-triethoxysilane);

SiO₂-APTES-DVS MPs: SiO₂-APTES MPs vinylsulfone-functionalized using DVS (divinylsulfone);

SiO₂-APTES-DVS-PEI MPs: SiO₂ @ PEI MPs, SiO₂-APTES-DVS MPs functionalized with branched PEI (polyethyleneimine);

SiO₂ @ FITC MPs: SiO₂ @ PEI MP fluorescence-labeled with FITC (fluorescein isothiocyanate isomer I).

FIG. 2 shows a result of measuring the zeta potential and average particle size of polyethyleneimine-functionalized silica microparticles as well as representative SEM images.

FIG. 3 is a schematic diagram of a hollow fiber membrane process using a pressurized module.

FIG. 4 shows the water flux and rejection rate of separation membranes at pristine, damaged and healed states as well as representative SEM images of a damaged separation membrane and a healed separation membrane.

FIG. 5 shows (a) a relative water flux change during a healing process and (b)-(d) SEM images of a pristine separation membrane, a defect-free area of a separation membrane healed with surface-functionalized silica microparticles and a defect-free area of a separation membrane healed with chitosan aggregates.

FIG. 6 shows (a) the transport of particles in a cross-flow filtration model on a vertically installed separation membrane and (b) a local drag force ratio estimated by using cross-flow and permeate flow.

FIG. 7 shows a result of observing FITC-labeled polyethyleneimine-functionalized silica microparticles deposited on a damaged part using a confocal laser scanning microscope.

FIG. 8 shows the water flux and microparticle rejection rate of a healed separation membrane measured after chemical cleaning.

### DETAILED DESCRIPTION

Hereinafter, the present disclosure is described in detail. The terms or words used in the present specification and claims should not be interpreted to be limited to common or dictionary meanings but should be interpreted to have meanings and concepts corresponding to the technical idea of the present disclosure based on the principle that an inventor can define terms appropriately to best describe his/her own invention.

The present disclosure provides a method for healing a damaged separation membrane for water treatment, including:

a step of filtering a solution containing polyethyleneimine-functionalized silica microparticles through a damaged separation membrane for water treatment;

a step of filtering a solution containing a dialdehyde compound through the damaged separation membrane for water treatment; and

a step of crosslinking the polyethyleneimine-functionalized silica microparticles with the dialdehyde compound.

The polyethyleneimine may be a branched polyethyleneimine.

The polyethyleneimine may be a linear or branched polyethyleneimine, specifically a branched polyethyleneimine.

When a branched polyethyleneimine is used, the efficiency of crosslinking between particles may be enhanced.

The polyethyleneimine may have a weight-average molecular weight of 1,000-100,000 Da.

More specifically, the polyethyleneimine may have a weight-average molecular weight of 1,000-100,000 Da, specifically 10,000-50,000 Da, more specifically 20,000-30,000 Da.

If the weight-average molecular weight of the polyethyleneimine is smaller than 1,000 Da, the damaged part of the separation membrane may not be healed enough due to insufficient crosslinking with the dialdehyde compound. And, if the weight-average molecular weight is larger than 100,000 Da, the polyethyleneimine is consumed unnecessarily and an additional process of washing the excess polyethyleneimine may be required.

The polyethyleneimine-functionalized silica microparticles may mean silica microparticles wherein the polyethyleneimine is chemically bonded to the surface of the silica microparticle.

The polyethyleneimine-functionalized silica microparticles may be particles modified as —(CH₂)ₙNH(CH₂)ₙSO₂(CH₂)ₙ— (n is an integer from 1 to 5) groups formed on the surface of silica beads are bound to the polyethyleneimine.

For example, the polyethyleneimine-functionalized silica microparticles may be particles modified as —(CH₂)₃NHCH₂SO₂(CH₂)₂— groups bound to the surface of silica beads are bound to the polyethyleneimine.

The polyethyleneimine-functionalized silica microparticles may be microparticles prepared by a method including:

a step of preparing aminopropyl-functionalized silica microparticles by reacting silica microparticles with (3-aminopropyl)-triethoxysilane;

a step of preparing vinylsulfone-functionalized silica microparticles by reacting the aminopropyl-functionalized silica microparticle with divinylsulfone; and

a step of reacting the vinylsulfone-functionalized silica microparticles with a polyethyleneimine.

The silica microparticles may be silica (SiO₂) microbeads having OH groups on the surface of the silica microparticles.

As the silica microparticles, commercially available silica microparticles may be used without limitation. Because silica microparticles of various sizes are commercially available, the size of the silica microparticles can be controlled based on the pore size of the separation membrane, the expected size of the damaged part and cross-flow rate.

In particular, the efficiency of the healing process can be enhanced by using silica microparticles with different sizes during the healing process of the damaged separation membrane.

The size of the silica microparticles may be controlled depending on the condition of the separation membrane.

The existing method for healing a separation membrane using chitosan aggregates is limited in that it is applicable only to separation membranes having pores which are smaller than the chitosan aggregates although it is difficult to control the size of the chitosan aggregates. In contrast, for the polyethyleneimine-functionalized silica microparticles, because the size of the silica microparticles can be controlled depending on conditions, this problem can be solved by using silica microparticles which are larger than the pores of the separation membrane.

In addition, because the silica microparticles are chemically stable whereas the chitosan aggregates are sensitive to pH, the chemical and mechanical stability of the healed separation membrane can be ensured.

The step of preparing the aminopropyl-functionalized silica microparticles by reacting the silica microparticles with (3-aminopropyl)-triethoxysilane may be performed for 1-3 hours under continuous stirring.

The step of preparing the vinylsulfone-functionalized silica microparticles by reacting the aminopropyl-functionalized silica microparticles with divinylsulfone may be performed by Michael addition of divinylsulfone to aminopropyl at room temperature for 1-3 hours.

The step of reacting the vinylsulfone-functionalized silica microparticles with polyethyleneimine may be performed for 6-36 hours, specifically for 12-24 hours, under stirring.

The dialdehyde compound may be one or more selected from glutaraldehyde, glyoxal, malondialdehyde, succindialdehyde, maleindialdehyde and phthaldialdehyde. Specifically, glutaraldehyde may be used.

The aldehyde group of the dialdehyde compound is crosslinked with the amine group of the polyethyleneimine bound to the silica microparticles. Through this, a matrix capable of sealing the damaged part of the separation membrane is formed.

The crosslinking may be achieved by forming an imine bond between the amine group of the polyethyleneimine and the aldehyde group of the dialdehyde compound.

The amine group of the polyethyleneimine is crosslinked with the aldehyde group of the dialdehyde compound to form a matrix at the damaged part of the separation membrane.

The step of filtering the solution containing the polyethyleneimine-functionalized silica microparticles through the damaged separation membrane for water treatment may be performed for 1-30 minutes, specifically for 3-10 minutes.

If the filtering time is outside the above range, the polyethyleneimine-functionalized silica microparticles may not be sufficiently deposited on the damaged part or may be unnecessarily deposited on the undamaged part.

In the method for healing a damaged separation membrane for water treatment, after the step of filtering the solution containing the polyethyleneimine-functionalized silica microparticles, a flushing process may be performed for 1-30 minutes using deionized water. Specifically, the flushing process may be performed for 5-20 minutes. More specifically, the flushing process may be performed for 7-15 minutes.

If the flushing time is shorter than the above range, the polyethyleneimine-functionalized silica microparticles may not be sufficiently deposited on the damaged part. And, if the flushing time exceeds the above range, unnecessary time may be spent.

The step of filtering the solution containing the dialdehyde through the damaged separation membrane for water treatment may be performed for 1-30 minutes, specifically for 5-20 minutes.

If the filtering time is outside the above range, the amount of the dialdehyde compound may be insufficient for the crosslinking or may be unnecessarily large.

The step of crosslinking the polyethyleneimine-functionalized silica microparticles with the dialdehyde compound may be performed by maintaining the filtered two compounds on the separation membrane at room temperature for a predetermined time.

More specifically, the step of crosslinking may be performed for 10 minutes to 5 hours, specifically for 20 minutes to 3 hours, more specifically for 30 minutes to 2 hours.

If the crosslinking is outside the above range, the crosslinking may not be achieved sufficiently or unnecessary time may be spent.

The separation membrane healed by the method for healing a damaged separation membrane for water treatment may exhibit a water permeability and a rejection rate of 90-99% as compared to those of a pristine separation membrane.

In an exemplary embodiment of the present disclosure, the healed separation membrane exhibits superior healing performance, with a water permeability of 97% and a rejection rate of 99% as compared to those of the pristine separation membrane.

In the method for healing a damaged separation membrane for water treatment, after the step of crosslinking, a flushing process may be performed for 1-30 minutes using purified water. Specifically, the flushing process may be performed for 5-20 minutes. More specifically, the flushing process may be performed for 7-15 minutes.

If the flushing time is shorter than the above range, the silica microparticles may be attached to the undamaged part. And, if the flushing time exceeds the above range, the functionalized silica microparticles deposited on the damaged part may be removed.

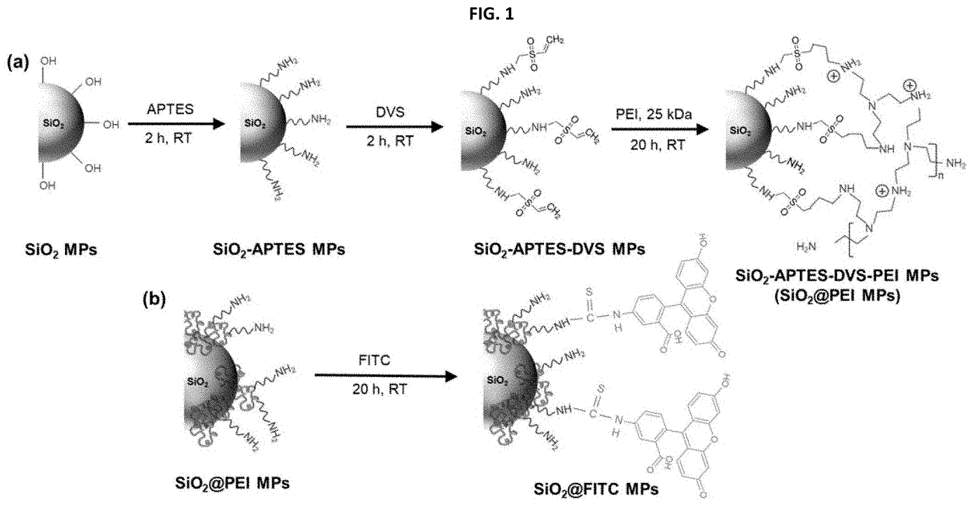

Hereinafter, the present disclosure will be described in detail through examples and test examples. However, the following examples may be modified into various other forms and it should not be interpreted that the scope of the present disclosure is limited by the examples. The examples of the present disclosure are provided to more fully describe the present disclosure to those of ordinary skill in the art.

<Preparation Example 1> Synthesis of surface-functionalized silica microparticle A process of synthesizing surface-functionalized silica microparticles is schematically described in (a) of FIG. 1.

First, silica microparticles (SiO₂ MPs, 2.2 μm diameter, Superior Silica LLC, USA) were washed with 80% v/v ethanol and filtered through a polyvinylidene fluoride (PVDF) disc membrane filter (HVLP Durapore membrane filter, EMD Millipore, USA) with a nominal pore of 0.45 μm followed by drying overnight in a vacuum oven.

To covalently attach polyethyleneimine (PEI) to the silica microparticles (SiO₂ MPs), the pretreated silica microparticles (SiO₂ MPs) were first transferred to a pure ethanol solution by a sonication (30 minutes)-centrifugation-redispersion process and dried in a vacuum oven. 0.5 g of the washed silica microparticles (SiO₂ MPs) were added to 200 mL of hexane and ultrasonicated for 30 minutes to obtain a monodispersed silica suspension, followed by reaction with 0.8 mL of (3-aminopropyl)-triethoxysilane (APTES) for 2 hours under continuous stirring. The resulting suspension was then washed twice to remove excess (3-aminopropyl)-triethoxysilane by centrifugation (6000 rpm, 30 minutes) and redispersion (sonication for 30 minutes) in pure ethanol.

The washed aminopropyl-functionalized silica microparticle (SiO₂-APTES MPs) suspension was dried and redispersed in 50 mL of 2-propanol. The suspension was completely dried in a vacuum oven at 100° C. for 20 hours.

Then, the aminopropyl-functionalized silica microparticles (SiO₂-APTES MPs) were transferred to 200 mL of 2-propanol. 400 μL of divinylsulfone (DVS) was added to the sonicated aminopropyl-functionalized silica microparticle (SiO₂-APTES MPs) suspension.

The resulting mixture, vinylsulfone-functionalized silica microparticles (SiO₂-APTES-DVS MPs), was stirred for 2 hours at room temperature, followed by washing and redispersing in 2-propanol. To introduce branched amine groups, 5 mL of a polyethyleneimine solution (500 mg of PEI in 5 mL of 2-propanol) was added and sonicated for 5 minutes. After overnight reaction under stirring, excess polyethyleneimine was washed by three cycles of centrifugation-redispersion with 2-propanol.

Finally, the polyethyleneimine-functionalized silica microparticles (SiO₂-APTES-DVS-PEI MPs, SiO₂ @ PEI MPs) were redispersed in 100 mL of ethanol (final concentration 5 g/L).

The hexane (for HPLC, >95%), (3-aminopropyl)-triethoxysilane (APTES, 99%), ethanol (200 proof, ACS reagent), divinylsulfone (DVS, 97%), polyethyleneimine (PEI, branched, MW 25,000 Da) and 2-propanol (anhydrous, 99.5%) used in the synthesis were purchased from Sigma-Aldrich (USA) and used as supplied without further purification.

### <Preparation Example 2> Synthesis of FITC-Labeled Silica Microparticles (SiO₂ @ FITC MPs)

Fluorescein isothiocyanate isomer I (FITC)-labeled silica microparticles (SiO₂ @ FITC MPs) were prepared to provide visual evidence of selective deposition of silica microparticles on the damaged part.

To synthesize FITC-labeled silica microparticles (SiO₂ @ FITC MPs), 5.25 mg of FITC was dissolved in 1 mL of dimethyl sulfoxide (DMSO) and mixed with mL of the polyethyleneimine-functionalized silica microparticles (SiO₂-APTES-DVS-PEI MPs, SiO₂ @ PEI MPs) prepared in Preparation Example 1 ((b) of FIG. 1). The mixture was stirred overnight at room temperature and then filtered with excess ethanol to remove impurities. Finally, the filtered mixture was dispersed in 20 mL of ethanol to form a suspension with a concentration of 5 g/L.

The fluorescein isothiocyanate isomer I (FITC, ≥97.5%) and dimethyl sulfoxide (DMSO, ≥99.5%) used in the synthesis were purchased from Sigma-Aldrich (USA) and used as supplied without further purification.

### <Test Example 1> Characterization of Functionalized Silica Microparticles

(1) Experimental Method

The hydrodynamic diameter and zeta potential of the surface-functionalized silica microparticles were measured in the suspension diluted with water after sonication for 30 minutes (NANO-BROOK OMNI, Brookhaven Instruments, USA). All the experiments to measure the zeta potential of the surface-functionalized silica microparticle suspension were performed using ultrapure water at pH 6.2.

SEM samples were prepared by dropping the diluted silica microparticle suspension onto a silicon wafer plate and drying overnight in a vacuum oven at room temperature. The surface morphology of the silica microparticles was imaged using a scanning electron microscope (SEM, Hitachi SU-70, Japan) after coating with a 4-nm thick layer of iridium (208HR, Cressington, USA). The obtained SEM images were analyzed by the ImageJ software (NIH, USA) to determine the actual size of the silica microparticles.

(2) Experimental Result

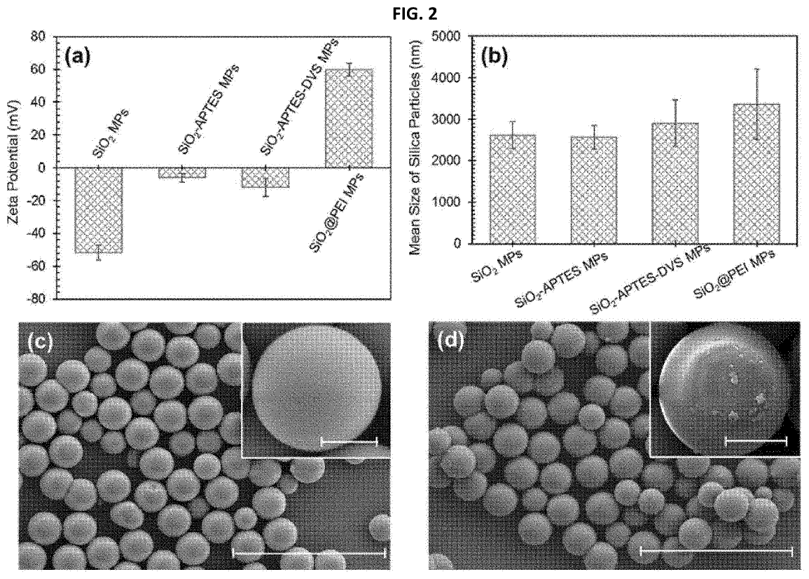

The functionalization of the silica microparticles with amine groups was confirmed by the zeta potential measurement ((a) of FIG. 2).

Prior to the modification, the silica microparticles had a low zeta potential (−51.6±4.7 mV) because of surface silanol groups. The addition of APTES, which binds to the surface of the silica microparticles through the hydrolysis of ethoxysilane groups and condensation with hydroxyl groups, increased the zeta potential value to −6.0±2.7 mV. It is though that this increase is due to the positively charged primary amine groups in the APTES.

After the second surface modification step in which the functional crosslinker DVS reacts rapidly with APTES through Michael addition, the silica microparticles became more negatively charged due to the introduction of the vinylsulfone group. The crosslinker is necessary to further functionalize the silica microparticles with the branched polyamine, which results in silica microparticles with a much larger ratio of amine terminal groups compared to the functionalization with APTES.

After this final step, the branched polyethyleneimine introduces sufficient amine groups, which provide sites for crosslinking with glutaraldehyde, to result in a positive charge of 59.7±3.9 mV.

As a result of dynamic light scattering analysis, the average particle diameter of the silica microparticles after surface modification with APTES was similar to that of the original microparticles (2.6±0.3 μm) and the average particle diameters of the silica microparticles after surface modification with DVS and PEI were 2.9±0.6 and 3.4±8.5 μm, respectively ((b) of FIG. 2).

The hydrodynamic diameter of the silica microparticles (2.6±0.3 μm) is expected to be larger than that of the average microparticle diameter measured by SEM (2.2±0.5 μm, (c) of FIG. 2) because of hydration of the particles as well as agglomeration of some particles in the aqueous phase. The SEM result shows that, while the surface morphology of the pristine silica microparticles was uniform and smooth, the polyethyleneimine-functionalized silica microparticles (SiO₂ @ PEI MP) had a rough and irregular morphology due to the attachment of PEI on the surface (see (d) of FIG. 2).

### <Example 1> Evaluation of Healing Performance of Method for Healing Separation Membrane Using Functionalized Silica Microparticles

(1) Method

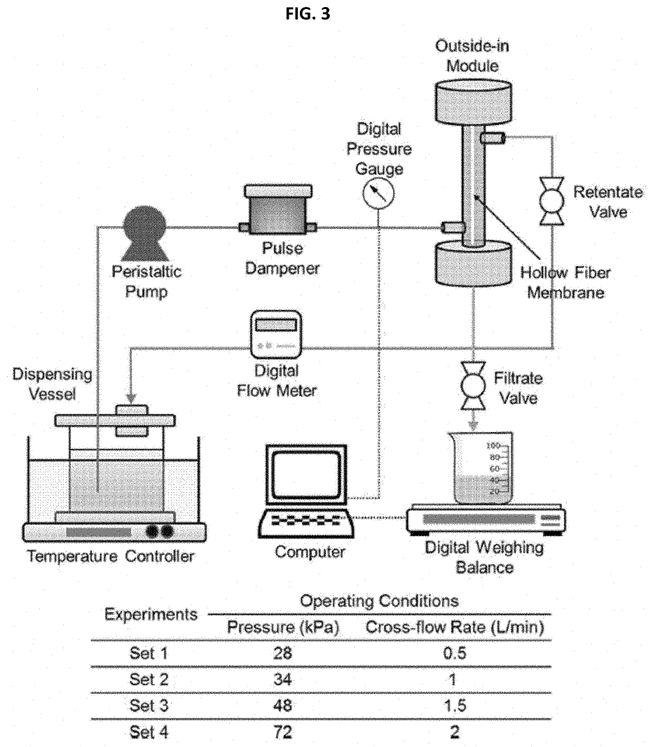

A cross-flow lab-scale filtration system was configured to operate at constant pressure using a pressurized PVDF hollow fiber module and a peristaltic pump as shown in FIG. 3. A single, 28 cm-long strand of hollow fiber (CLEANFIL, Kolon Industry, Inc., 0.1 μm nominal pore size) with an effective filtration area of 17.6 cm² was mounted in the custom-built module and continuously supplied with a feed solution from a dispensing vessel in an outside-in configuration.

Operating pressure (28-72 kPa) and cross-flow velocity (3.79×10⁻² to 1.52×10⁻¹ m/s) were controlled by a peristaltic pump and retentate valve. The operating pressure and flow rate of the retentate were measured by a digital pressure gauge (ISE40A, SMC, Japan) and a flow meter (Flow S-110, McMillan, USA), respectively. The installed hollow fiber membrane was precompacted at 50 kPa for 2 hours before measuring the water permeability on a digital weighing balance every 1 minute. The rejection rate was measured with a fluorescent microsphere feed solution (FLUORESBRITE YG Microspheres, 1.0 μm, Polyscience Inc., USA) at a concentration of 0.025 g/L. The concentration of fluorescent microspheres in the permeate was measured with a spectrofluorophotometer (Shimadzu RF-5031 PC, Japan) at an excitation wavelength of 441 nm and an emission wavelength of 486 nm.

To create consistently sized damages on the hollow fiber membrane, a specially designed damaging device was used. The hollow fiber membrane was laterally positioned between support cover slides, and a vertically positioned microtome blade (MB35 Premier, Thermo Scientific, USA) was used to damage the membrane. Briefly, 5 mL of the polyethyleneimine-functionalized silica microparticles suspension prepared in Preparation Example 1 was injected into the dispensing vessel that contained 2 L of purified water. Filtration through the damaged membrane was carried out for 5 minutes, followed by flushing with deionized water for 10 minutes and filtration of a 3 wt % glutaraldehyde solution for 10 minutes, under various pressures and cross-flow rates. The membrane was kept at room temperature for 1 hour without any filtration for the crosslinking reaction to occur.

Finally, the separation membrane system was washed with purified water for 30 minutes under the same operating condition as the filtration of the polyethyleneimine-functionalized silica microparticles. The healed separation membrane area morphology was observed using an SEM.

The sampled hollow fiber membrane specimens were dried in a vacuum oven at room temperature for 24 hours and sputter-coated with 4 nm of iridium coating before SEM analysis.

(2) Result

The filtration of the polyethyleneimine-functionalized silica microparticles through the damaged hollow fiber membrane followed by healing through crosslinking with glutaraldehyde successfully recovered the membrane's original properties such as water flux and particle rejection.

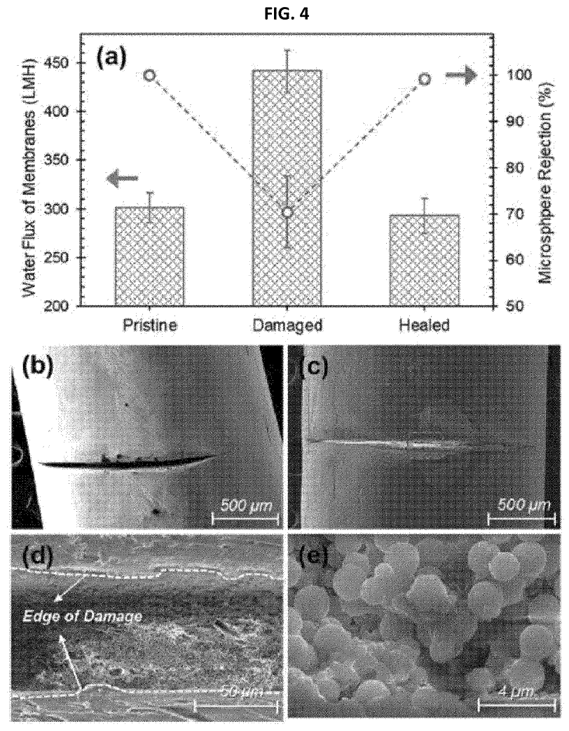

To examine the healing performance, a pristine membrane was damaged using a microtome device, resulting in a damage with an approximate area of 0.109 mm² (see (b) of FIG. 4).

The damage to the separation membrane increased the water flux from 301±15 L·m⁻²·h⁻¹(LMH) to 442±22 LMH and decreased the particle rejection rate from 99% to 70.4±7.8%. After the healing process, the water flux through the membrane was restored to 293±18 LMH and the particle rejection rate was restored to 99.1±1.0%, which corresponds to 97% and 99% performance recovery, respectively (see (a) of FIG. 4).

The SEM images show that after the healing process, the polyethyleneimine-functionalized silica microparticles (SiO₂ @ PEI MP) are deposited at the damaged part forming a particle network that completely plugs the damage part (see (c) of FIG. 4 and (d) of FIG. 4). Higher magnification SEM image show a structure in which PEIs form bridges between the polyethyleneimine-functionalized silica microparticles (SiO₂ @ PEI MP), which are formed when the primary amine functional group of the branched PEIs reacts with the aldehyde functional group in the glutaraldehyde to form a macromolecular structure (see (e) of FIG. 4).

### <Example 2> Observation of Selective Deposition of Functionalized Silica Microparticles on Damaged Part of Separation Membrane

(1) Method

The synthesized FITC-labeled silica microparticles (SiO₂ @ FITC MPs) suspension (0.0025 wt %) was injected into the dispensing vessel and filtered through a damaged membrane at various pressure and cross-flow velocity conditions.

To avoid photobleaching of FITC by external light sources, the filtration was performed in the dark by covering the module with an aluminum foil. After filtration, the hollow fiber membrane was imaged using a confocal laser scanning microscope (CLSM, Nikon C2, Japan).

The obtained images were analyzed using a 3D image process/analysis software (IMARIS 6.1.5, Bitplane, Switzerland).

(2) Result

Preferential deposition of the polyethyleneimine-functionalized silica microparticles on the damage part, rather than the rest of the membrane, during the healing process is necessary to successfully restore damages without particles depositing on the defect-free membrane area. Particle deposition on the defect-free membrane area would result in a decline in flux through the membrane after the healing process to levels much lower than the pristine membrane's permeability.

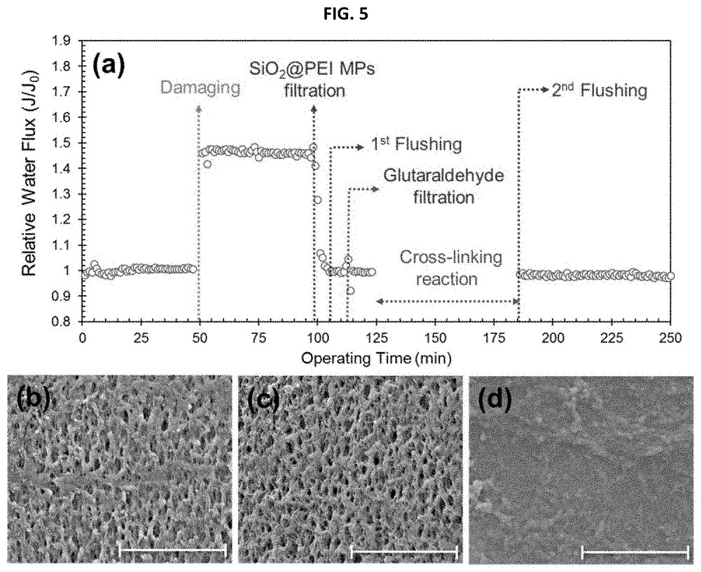

During the healing using the polyethyleneimine-functionalized silica microparticles, the water flux through the damaged separation membrane increased by 46.6% relative to the pristine separation membrane and was rapidly recovered to the original value within 5 minutes after the filtration of the polyethyleneimine-functionalized silica microparticles (see (a) of FIG. 5).

Since the flux did not decrease further during the subsequent 60 minutes of operation, it can be assumed that particles sitting on the undamaged part were washed out during the flushing process. This is corroborated by the SEM image of the membrane after the healing, where the undamaged membrane area looks identical to the pristine membrane separation (see (b) of FIG. 5 and (c) of FIG. 5).

In contrast, during the healing of the damaged separation membrane with chitosan agglomerates under similar operating conditions, the intact membrane surface was partly covered with the healing agent leading to a decline in membrane permeability (see (d) of FIG. 5).

The healing method using the polyethyleneimine-functionalized silica microparticles did not result in particle accumulation on the surface of the undamaged separation membrane for two reasons. First, it is because the particle diameter (≥2.0 μm) was much larger than the nominal pore diameter (0.1 μm) of the separation membrane. The second reason is the selectivity of the polyethyleneimine-functionalized silica microparticles.

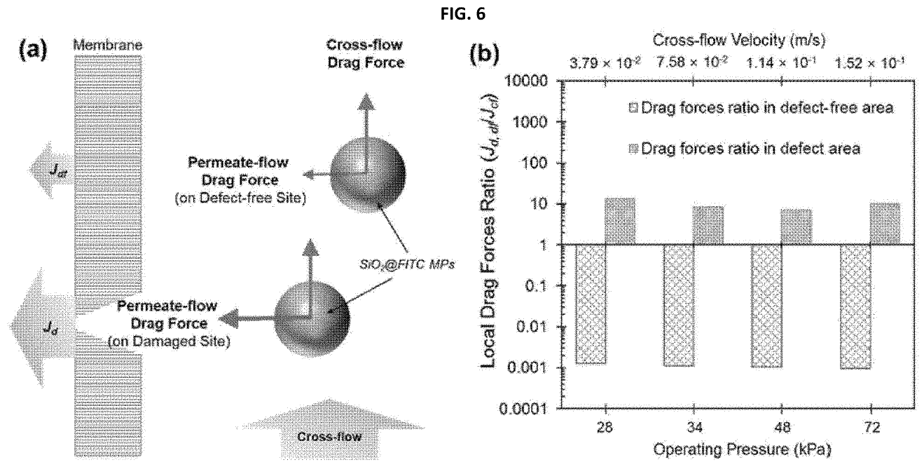

The selectivity of the microparticles arises from the ratio of drag forces that determine the particle's movement, namely, the ratio between the cross-flow and permeate flow drag forces. When the membrane is damaged, the permeate flux through the damage part increases significantly, increasing the ratio of permeate-flow to cross-flow drag forces in that area. More specifically, in the undamaged separation membrane, the cross-flow velocity is 3 orders of magnitude higher than the permeate velocity, while in the damaged membrane the permeate velocity in the damage part is 10 times higher than the crossflow velocity (see FIG. 6). Therefore, the polyethyleneimine-functionalized silica microparticles preferentially migrate toward the damage part driven by the increased hydraulic drag. The local drag force ratio is maintained regardless of the cross-flow velocity, that is, even when the cross-flow velocity is increased, a proportional increase in the permeate flow drag occurs due to the change in operation pressure.

Further visual evidence for the preferential deposition of the polyethyleneimine-functionalized silica microparticles on the damage part is found in the reconstructed confocal laser scanning microscope (CLSM) images of the healed hollow fiber membrane.

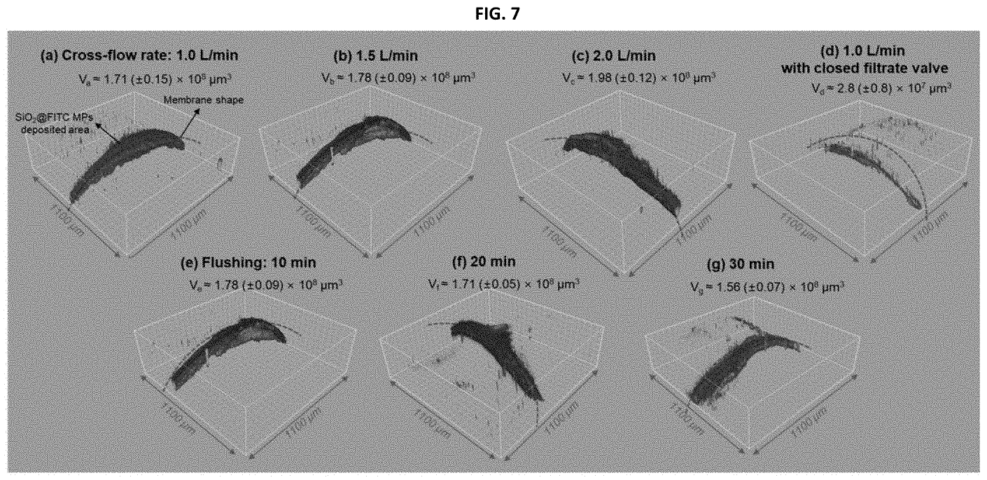

(a)-(c) of FIG. 7 show that the amount of the SiO₂ @ FITC MPs deposited on the damage part was very similar under varying cross-flow rates ranging from of 1.0-2.0 L/min. When the permeate velocity is reduced down to zero by closing the filtrate valve, the amount of the SiO₂ @ FITC MPs that are deposited on the damage part decreases by 83% as shown in (d) of FIG. 7. These results further confirm that it is the local drag force ratio that primarily determines the microparticle deposition on the damage part.

In addition, it was confirmed that the SiO₂ @ FITC MPs deposited on the damage part would not be desorbed during the flushing process. The amount of the residual SiO₂ @ FITC MPs on the damage part was very similar at flushing times of 10, 20, and 30 minutes, as seen from (e)-(g) of FIG. 7. As a result, a flushing time of 10 minutes would be optimal for cleaning the membrane without desorbing any of the particles on the damage part.

### <Test Example 2> Evaluation of Physical and Chemical Stability of Healed Separation Membrane

(1) Experimental Method

The physical and chemical stability of the healed separation membrane is a critical requirement for practical application of this healing method. The membrane healed with the polyethyleneimine-functionalized silica microparticles prepared in Preparation Example 1 was chemically cleaned by immersing in 100 mg/L of sodium hypochlorite for one hour every day under operation conditions of 34 kPa of operating pressure and 1.0 L/min of cross-flow rate. This cleaning was conducted for 31 days and water permeability and rejection rate were measured immediately after the chemical cleaning.

(2) Experimental Result

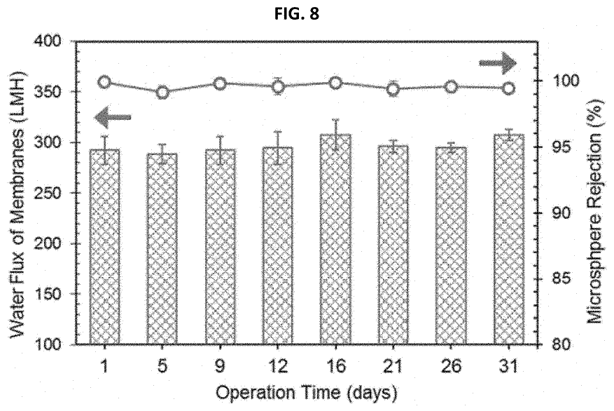

The experimental result is shown in FIG. 8.

As seen from the figure, the healed separation membrane maintained a constant flux without any change in rejection rate during the long-term experiment performed for 31 days.

Under four different operating conditions, the water permeability and rejection rate of the healed separation membrane remained at 95.6% and 98.9% of the original separation membrane, respectively.

These results suggest that the polyethyleneimine-functionalized silica microparticles have sufficient mechanical/chemical stability during the healing process.

1. A method for healing a damaged separation membrane for water treatment, the method comprising:
filtering a solution comprising polyethyleneimine-functionalized silica microparticles through a damaged separation membrane for water treatment;
filtering a solution comprising a dialdehyde compound through the damaged separation membrane for water treatment; and
crosslinking the polyethyleneimine-functionalized silica microparticles with the dialdehyde compound.

2. The method for healing a damaged separation membrane for water treatment according to claim 1, wherein the polyethyleneimine is a branched polyethyleneimine.

3. The method for healing a damaged separation membrane for water treatment according to claim 1, wherein the polyethyleneimine has a weight-average molecular weight of 1,000-100,000 Da.

4. The method for healing a damaged separation membrane for water treatment according to claim 1, wherein the polyethyleneimine-functionalized silica microparticles are silica beads, wherein (CH₂)ₙNH(CH₂)ₙSO₂(CH₂)ₙ—, where n is an integer from 1 to 5, formed on the surface of the silica beads are bound to a polyethyleneimine, where n is an integer from 1 to 5.

5. The method for healing a damaged separation membrane for water treatment according to claim 1, wherein the polyethyleneimine-functionalized silica microparticles are microparticles prepared by a process comprising:
preparing aminopropyl-functionalized silica microparticles by reacting silica microparticles with (3-aminopropyl)-triethoxysilane;
preparing vinylsulfone-functionalized silica microparticles by reacting the aminopropyl-functionalized silica microparticle with divinylsulfone; and
reacting the vinylsulfone-functionalized silica microparticles with a polyethyleneimine.

6. The method for healing a damaged separation membrane for water treatment according to claim 1, wherein the dialdehyde compound is one or more selected from the group consisting of glutaraldehyde, glyoxal, malondialdehyde, succindialdehyde, maleindialdehyde and phthaldialdehyde.

7. The method for healing a damaged separation membrane for water treatment according to claim 1, wherein the crosslinking is achieved by forming an imine bond between the amine group of the polyethyleneimine and the aldehyde group of the dialdehyde compound.
